(19) United States
(12) Patent Application Publication
(10) Pub. No.: US 2026/0031486 A1
(43) Pub. Date: Jan. 29, 2026

(54) SECONDARY BATTERY

(71) Applicant: Prime Planet Energy & Solutions, Inc., Tokyo (JP)

(72) Inventor: Satoshi FUJIMURA, Toki-shi (JP)

(21) Appl. No.: 19/239,953

(22) Filed: Jun. 17, 2025

(30) Foreign Application Priority Data
Jul. 24, 2024 (JP) 2024-118631

(51) Int. Cl. H01M 50/489; H01M 10/0525; H01M 10/0587; H01M 50/103; H01M 50/466; H01M 50/474; H01M 50/483; H01M 50/486

(52) U.S. Cl. CPC H01M 50/489; H01M 10/0525; H01M 10/0587; H01M 50/103; H01M 50/466; H01M 50/474; H01M 50/483; H01M 50/486

(57) ABSTRACT

A secondary battery includes an electrode body, in which a positive electrode formed of a positive electrode foil coated with a positive active material layer and a negative electrode formed of a negative electrode foil coated with a negative active material layer are stacked with separators interposed between them, a battery case that hermetically houses the electrode body, and a shielding member placed between the electrode body and the battery case to shield against ejected substances, which are ejected from the electrode body toward the battery case, due to a short circuit between the positive electrode and the negative electrode.

### CROSS-REFERENCE TO RELATED APPLICATIONS

This application is based upon and claims the benefit of priority to Japanese Patent Application No. 2024-118631 filed on Jul. 24, 2024, the entire contents of which are incorporated herein by reference.

### BACKGROUND

### Technical Field

The disclosure relates to a secondary battery.

### Related Art

In recent years, secondary batteries for use in electric vehicles and others have been increasingly demanded to have larger size and higher energy density, etc.

In such batteries with larger size and higher energy density, a large amount of high-temperature ejected materials (ejected substances) and gas could be generated in the event that a short circuit or other failures occur in an electrode body. In this case, the hot ejected substances that are continuously ejected from gaps between a positive electrode and a negative electrode could melt the wall surfaces of a battery case, causing rupture or breakage of the battery case.

To avoid the above-mentioned defects, for example, Japanese unexamined patent application publication No. H11(1999)-191400 discloses the following features:
(1) the battery case is formed of a multiple structure including an outer layer made of high-rigid material, such as a steel, and an inner layer made of plastic having gas absorption property; and
(2) the electrode body is enclosed in a laminate film including an aluminum foil as an intermediate layer and plastic films laminated on both sides of the aluminum foil.

### SUMMARY

### Technical Problems

To form the battery case as the multiple structure composed of different members, for example, there is a method of drawing a clad material plate consisting of different members. However, this method is not preferable because cracks and the like are apt to occur during forming. In another method, an outer layer case and an inner layer case are separately formed and then combined together with adhesive, etc. However, this method is also undesirable because it needs a complicated process and leads to higher costs. Furthermore, the laminate film formed of the aluminum foil as the intermediate layer and the plastic films laminated on both sides of the aluminum foil is apt to be melted by high-temperature ejected substances. Thus, this structure is not expected to have the effect of preventing the battery case from rupturing or melting.

The present disclosure has been made to address the above problems and has a purpose to provide a secondary battery with a simple structure capable of effectively reducing melting, rupturing, and other defects of a battery case due to high-temperature ejected substances that are continuously generated in the event that a short circuit or other defects occur in an electrode body.

### Means of Solving the Problems

(1) To achieve the above-mentioned purpose, one aspect of the present disclosure provides a secondary battery comprising: an electrode body including a positive electrode formed of a positive electrode foil coated with a positive active material layer and a negative electrode formed of a negative electrode foil coated with a negative active material layer, the positive and negative electrodes being stacked with separators interposed between them; a battery case in which the electrode body is hermetically housed; and a shielding member placed between the electrode body and the battery case to shield against ejected substances that are ejected from the electrode body toward the battery case.

(2) In the secondary battery described in (1), the shielding member may include: a shielding portion placed facing an electrode-body open edge where an edge portion of the positive electrode and an edge portion of the negative electrode are opened in a direction perpendicular to a stacking direction of the electrode body; and a shield supporting portion that supports the shielding portion at a distance from an inner wall surface of the battery case.

(3) In the secondary battery described in (1) or (2), the shielding member may be formed of (i) a metal member coated with an insulating member, the metal member having a melting point higher than either a melting point of the positive electrode foil or a melting point of the negative electrode foil, whichever is higher, or (ii) an insulating organic material having a melting point higher than either the melting point of the positive electrode foil or the melting point of the negative electrode foil, whichever is higher.

(4) In the secondary battery described in any one of (1) to (3), the shielding member may be connected to or integrally formed with an insulating film enclosing the electrode body.

### BRIEF DESCRIPTION OF THE DRAWINGS

FIG. 1 is a schematic cross-sectional diagram of a secondary battery in a first example, which is one aspect of an embodiment;

FIG. 2 is a cross-sectional diagram taken along a line A-A in FIG. 1;

FIG. 3 is a cross-sectional diagram taken along a line B-B in FIG. 1;

FIG. 4 is a schematic perspective diagram of a shielding member in the secondary battery shown in FIG. 1;

FIG. 5 is a B-B cross-sectional diagram in a modified example 1 of the secondary battery shown in FIG. 1;

FIG. 6 is a B-B cross-sectional diagram in a modified example 2 of the secondary battery shown in FIG. 1;

FIG. 7 is a schematic cross-sectional diagram of a secondary battery in a second example, which is another aspect of the embodiment;

FIG. 8 is a cross-sectional diagram taken along a line C-C in FIG. 7;

FIG. 9 is a cross-sectional diagram taken along a line D-D in FIG. 7;

FIG. 10 is a schematic perspective diagram of a shielding member in the secondary battery shown in FIG. 7;

FIG. 11 is a schematic cross-sectional diagram of a secondary battery in a third example, which is another aspect of the embodiment;

FIG. 12 is a cross-sectional diagram taken along a line E-E in FIG. 11;

FIG. 13 is a cross-sectional diagram taken along a line F-F in FIG. 11; and

FIG. 14 is a schematic perspective diagram of a shielding member in the secondary battery shown in FIG. 11.

### DETAILED DESCRIPTION OF THE EXEMPLARY EMBODIMENTS

### Secondary Battery in First Example

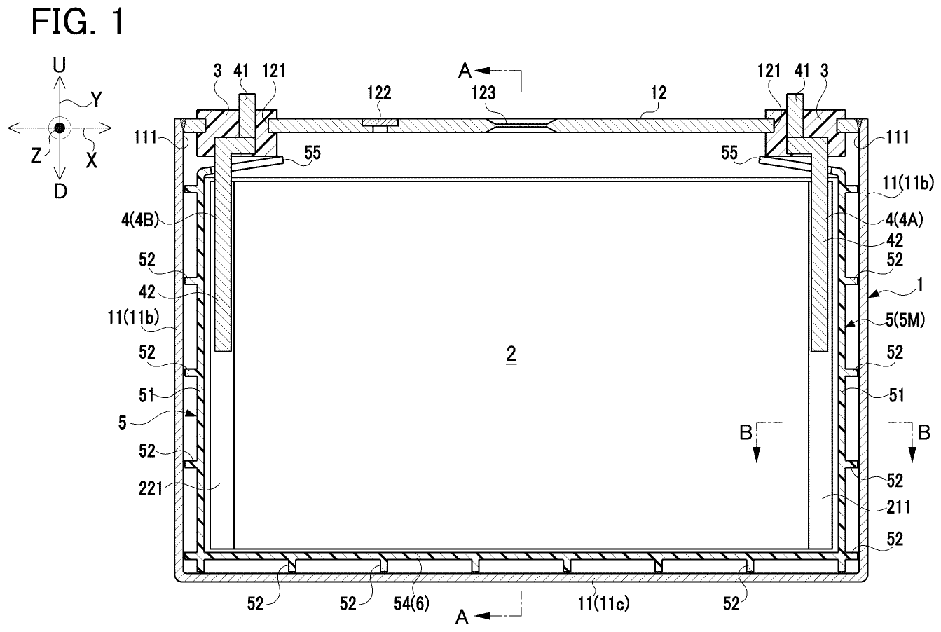

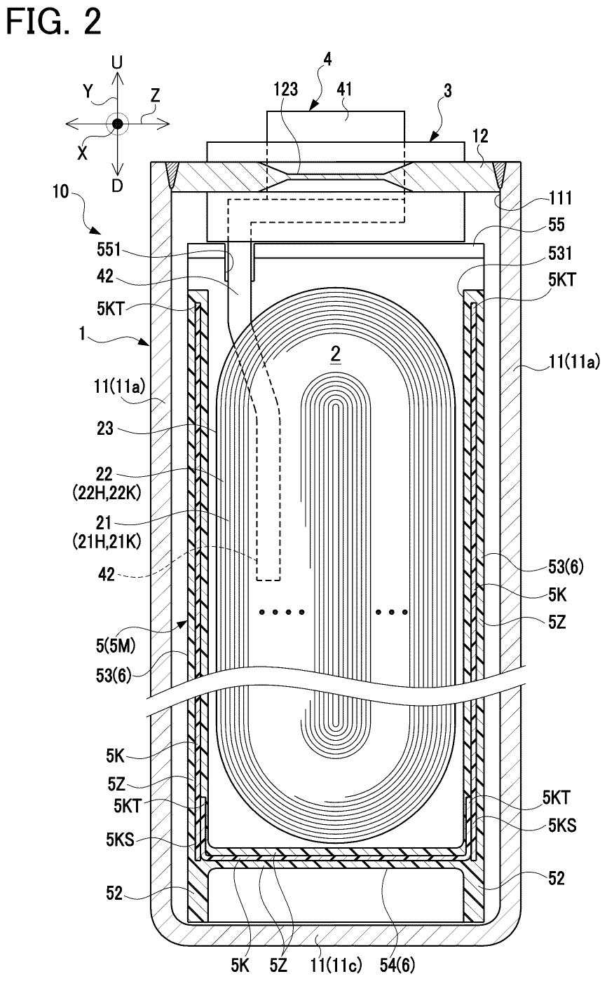

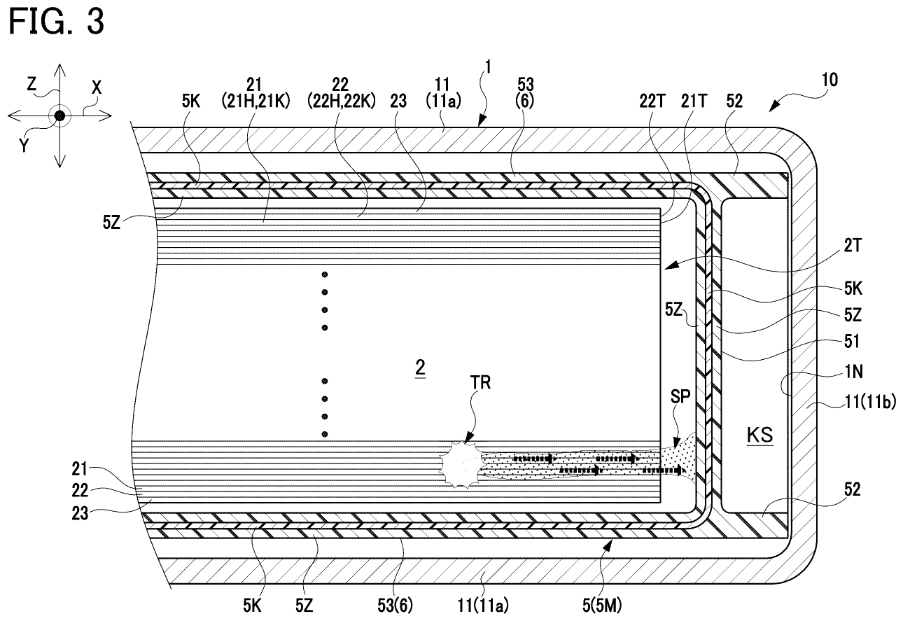

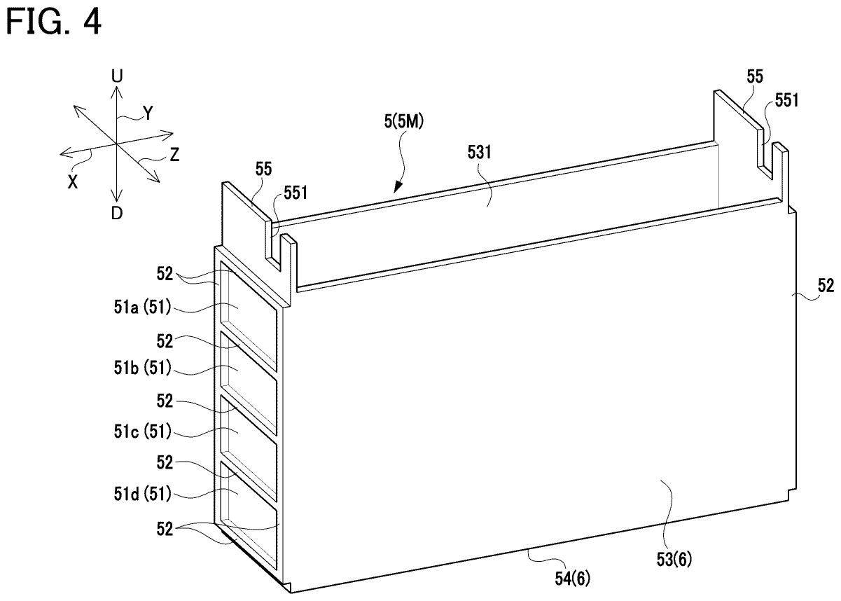

A detailed description of the structure of a secondary battery in a first example, which is one aspect of an embodiment of this disclosure, will now be given referring to the accompanying drawings. FIG. 1 is a schematic cross-sectional diagram of the secondary battery in the first example, which is one aspect of the embodiment. FIG. 2 is a cross-sectional diagram taken along a line A-A in FIG. 1. FIG. 3 is a cross-sectional diagram taken along a line B-B in FIG. 1. FIG. 4 is a schematic perspective diagram of a shielding member in the secondary battery shown in FIG. 1. In the figures, the direction X indicates a long-side direction of a battery case, the direction Y indicates a vertical direction of the battery case, and the direction Z indicates a short-side direction, i.e., a width direction, of the battery case. Further, an arrow U denotes the upper side and an arrow D denotes the lower side of the battery case. The same definition applies to the following description.

A secondary battery 10 in the first example includes a battery case 1, an electrode body 2, current collecting terminals 4, and a shielding member 5, as shown in FIGS. 1 to 4. Here, the battery case 1 includes a rectangular prismatic case body 11 with a closed bottom, which has a rectangular opening portion 111 at the upper end so that the electrode body 2 can be inserted through the opening portion 111, and a long flat-plate-shaped lid member 12 that closes the opening portion 111. The case body 11 is composed of a pair of long side walls 11a extending in the long-side direction (the direction X), a pair of short side walls 11b extending in the short-side direction (the direction Z), and a bottom wall 11c joined to the lower ends of the long side walls 11a and the short side walls 11b. The battery case 1 may be made of an aluminum material or an aluminum alloy material, for example.

Further, the lid member 12 is formed, near its both ends in the long-side direction (the direction X), with insertion holes 121 in which the current collecting terminals 4 (4A, 4B) are inserted respectively. An outer terminal 41 of each current collecting terminal 4 inserted in the corresponding insertion hole 121 is fixed to the lid member 12 via an insulating resin member 3. The insulating resin members 3 may be made of, for example, polyphenylene sulfide (PPS) resin. The lid member 12 is provided with an inlet 122 through which an electrolyte is poured into the battery case 1 and a safety valve 123 that can be opened when the gas pressure in the battery case 1 rises to a predetermined value or higher. The electrolyte poured through the inlet 122 is impregnated mainly in the electrode body 2. The battery case 1 is not limited to the above-mentioned form as long as its inside is hermetically sealed.

The electrode body 2 includes a positive electrode 21 and a negative electrode 22, which are stacked in layers with separators 23 interposed between them. The positive electrode 21 is formed of a positive electrode foil 21H and positive active material layers 21K applied to, or coated on, both sides of this foil 21H. The negative electrode 22 is formed of a negative electrode foil 22H and negative active material layers 22K applied to, or coated on, both sides of this foil 22H. In this example, the electrode body 2 has a flat wound shape in which a strip-shaped positive electrode 21 and a strip-shaped negative electrode 22 are stacked with strip-shaped separators 23 interposed between them. The electrode body 2 is formed, at both ends in the long-side direction (the direction X), with an active material uncoated portion 211 of the positive electrode 21 and an active material uncoated portion 221 of the negative electrode 22. Further, the active material uncoated portion 211 of the positive electrode 21 is joined to an inner terminal 42 of a current collecting terminal 4A for positive electrode, and the active material uncoated portion 221 of the negative electrode 22 is joined to an inner terminal 42 of a current collecting terminal 4B for negative electrode.

For example, in a lithium ion secondary battery, which is one example of the secondary battery 10 in the present embodiment, the positive electrode foil 21H of the positive electrode 21 may be formed of for example an aluminum foil and the positive active material layers 21K coated thereon may be made of for example lithium transition metal oxide (LiNi_{1/3}Co_{1/3}Mn_{1/3}O₂, LiNiO₂, etc.), or other active materials. The negative electrode foil 22H of the negative electrode 22 may be formed of for example a copper foil and the negative active material layers 22K coated thereon may be made of for example black carbon, hard carbon, soft carbon, or other active materials. The separators 23 may be porous sheets made of for example polypropylene resin, polyethylene resin, etc. The positive current collecting terminal 4A is made of for example aluminum and the negative current collecting terminal 4B is made of for example copper.

The shielding member 5 is placed between the electrode body 2 and the battery case 1 to shield against, or block, ejected substances SP, which are ejected from the electrode body 2 toward the battery case 1 due to, e.g., a short circuit TR between the positive electrode 21 and the negative electrode 22, the ejected substances SP having higher temperatures than the melting point of the battery case 1. Even when the short circuit TR occurs due to intrusion of foreign substances into the electrode body 2, and high-temperature ejected substances SP are continuously ejected through gaps between the positive electrode 21 and the negative electrode 22 toward the battery case 1, the shielding member 5 can prevent the ejected substances SP from directly impacting the battery case 1. This can reduce the possibility that the hot ejected substances SP melt the wall surfaces of the battery case 1, causing cracks or ruptures in the battery case 1.

In this example, the shielding member 5 includes shielding portions 51 placed between the electrode body 2 and each short side wall 11b of the case body 11 to face the short side wall 11b, which will be also referred to as short-wall-side shielding portions 51, shielding portions 53 placed between the electrode body 2 and each long side wall 11a of the case body 11 to face the long side wall 11a, which will be also referred to as long-wall-side shielding portions 53, and a shielding portion 54 placed between the electrode body 2 and a bottom wall 11c of the case body 11 to face the bottom wall 11c, which will be also referred to as a bottom-wall-side shielding portion 54. The shielding member 5 has a bottomed rectangular prismatic shape formed of the short-wall-side shielding portions 51, the long-wall-side shielding portions 53, and the bottom-wall-side shielding portion 54, which are integrally joined to each other. The shielding member 5 may be a bottomed rectangular prismatic shape with arc-shaped or chamfered corners. This is because such corners can stretch when exposed to high-temperature and high-pressure gas generated by a short circuit TR in the electrode body 2, thus avoiding cracks.

An upper end portion of each of the short-wall-side shielding portions 51 may be provided with a shielding portion 55 placed to face the lid member 12, which will be also referred to as a lid-side shielding portion 55, extending to shield the insulating resin members 3 that fix the outer terminals 41 to both end portions of the lid member 12 in the long-side direction (the direction X). In this example, the lid-side shielding portions 55 are formed within a range to protect the insulating resin members 3 from ejected substances SP that spatter or fly off upward above the electrode body 2. Each of the lid-side shielding portions 55 is formed with a cutout 551 for insertion of the inner terminal 42 of the corresponding current collecting terminal 4. An upper end portion 531 of the shielding member 5 is formed to open upward for insertion of the electrode body 2 into the battery case 1, and communicate with the inlet 122 and the safety valve 123 each formed in the lid member 12. This is to facilitate impregnation of the electrolyte poured through the inlet 122 into the electrode body 2 and release of high-temperature and high-pressure gas through the safety valve 123.

The shielding member 5 in this example is provided with the shielding portions 51 (corresponding to the short-wall-side shielding portions 51) each facing an electrode-body open edge 2T where an edge portion 21T of the positive electrode 21 and an edge portion 22T of the negative electrode 22 are both opened in the direction perpendicular to the stacking direction of the electrode body 2, and the shield supporting portions 52 each supporting the shielding portions 51 at a distance from the inner wall surface IN of the battery case 1.

This is because the ejected substances SP generated when the positive electrode 21 and the negative electrode 22 are short-circuited are mostly ejected from the electrode-body open edges 2T where the edge portions 21T of the positive electrode 21 and the edge portions 22T of the negative electrode 22 are opened, in the direction perpendicular to the stacking direction of the electrode body 2, the short-wall-side shielding portions 51, which face the electrode-body open edges 2T, can more effectively block the ejected substances SP, as shown in FIG. 3. Further, the shielding member 5 includes the shield supporting portions 52 that support the shielding portions 51 at a distance from the inner wall surface IN of the battery case 1, so that an air layer KS is formed between the shielding member 5 and the battery case 1, suppressing the heat of the ejected substances SP from transferring from the shielding portions 51 to the inner wall surface IN of the battery case 1. This configuration can more effectively block the heat of the ejected substances SP to reduce melting and rupture of the battery case 1.

The shield supporting portions 52 may be formed at both ends of each shielding portion 51 in the width direction (the direction Z) and at positions that divide each shielding portion 51 into two or more shielding sections 51a to 51d in the vertical direction (the direction Y), as shown in FIGS. 1 and 4. Further, the shield supporting portions 52 may be formed at both ends of the shielding portion 54 (the direction Z) and at positions that divide the shielding portion 54 into two or more sections in the long-side direction (the direction X), as shown in FIGS. 1 and 2. With this configuration, the shielding portions 51 and 54 are unlikely to be deformed against the impact force of the ejected substances SP, and thus the ejected substances SP and resulting heat are unlikely to enter gaps between the shielding portions 51, 54 and the inner wall surface IN of the battery case 1. This leads to improved shielding performance of the shielding member 5.

The shielding member 5 may be formed of a metal member 5K coated with an insulating member 5Z, as shown in FIGS. 2 and 3, in which the metal member 5K has a higher melting point than either the melting point of the positive electrode foil 21H or the melting point of the negative electrode foil 22H, whichever is higher. The ejected substances SP will fly off mainly from the melted positive electrode foil 21H or negative electrode foil 22H. Thus, the metal member 5K having the higher melting point than the higher one of either the melting point of the positive electrode foil 21H or the melting point of the negative electrode foil 22H is unlikely to be melted by the ejected substances SP. The thus configured shielding member 5 can maintain its shielding performance even when the ejected substances SP are continuously ejected for a long time. An end portion 5KT of the metal member 5K may also be coated with the insulating member 5Z to avoid corrosion of the metal member 5K caused by the electrolyte, etc.

Specifically, when the positive electrode foil 21H is for example an aluminum foil, whose melting point is about 660° C., and the negative electrode foil 22H is for example a copper foil, whose melting point of about 1085° C., the metal member 5K may be made of any metal having a higher melting point than the copper's melting point (about 1085° C.) without being particularly specified. For example, since stainless steel has a melting point of about 1400° C. to 1500° C., the metal member 5K may be formed of a stainless steel foil with a thickness of about 0.1 mm to 0.3 mm. The metal member 5K may also be formed of a nickel foil whose melting point is about 1455° C. Still further, the metal member 5K may be configured as a single-layer foil, or as a multi-layer foil containing an air layer as an intermediate layer. The insulating member 5Z may be made of, for example, polypropylene resin, polyethylene resin, etc.

The shielding member 5 may also be formed of an insulating organic material 5M having a higher melting point than either the melting point of the positive electrode foil 21H or the melting point of the negative electrode foil 22H, whichever is higher. This insulating organic material 5M may be made of, for example, alumina (whose melting point is about 2050° C.), zircon (whose melting point is about 1775° C.), etc.

As shown in FIGS. 1 to 4, the shielding member 5 is formed in a bottomed rectangular prismatic shape including the short-wall-side shielding portions 51, the long-wall-side shielding portions 53, and the bottom wall shielding portion 54, which are integrally joined to each other. Accordingly, each shielding portion 51, 53, and 54 may be configured such that the metal member 5K having the higher melting point than the higher one of either the melting point of the positive electrode foil 21H or the melting point of the negative electrode foil 22H is coated with the insulating member 5Z. In this case, as shown in FIGS. 2 and 3, the metal member 5K in the short-wall-side shielding portions 51 and the long-wall-side shielding portions 53 is formed in a rectangular ring shape, the metal member 5K in the bottom wall shielding portion 54 is formed in a hat-like cross-section, and the lower portion 5KS of the metal member 5K in the short-wall-side shielding portions 51 and the long-wall-side shielding portions 53 and the upper portion 5KT of the metal member 5K in the bottom wall shielding portion 54 are joined to each other.

For the flat wound electrode body 2 shown in FIG. 2, the shielding member 5 may be configured such that the short-wall-side shielding portions 51, which are likely to be exposed to the ejected substances SP, are each formed of the metal member 5K coated with the insulating member 5Z, and other shielding portions 53 and 54, which enclose the electrode body 2, are formed of an insulating film 6 made of only the insulating member 5Z, and the shielding portions 51 are connected to or integrally formed with the shielding portions 53 and 54, i.e., the insulating film 6. This configuration can reduce the weight of the shielding member 5. Further, the positional displacement between the electrode body 2 and the shielding member 5 can be reduced, enabling to more reliably block the ejected substances SP to shield the battery case 1. Moreover, the shielding member 5 and the insulating film 6 can be housed together in the battery case 1, leading to further simplification of battery assembling works.

### Modified Examples 1 and 2

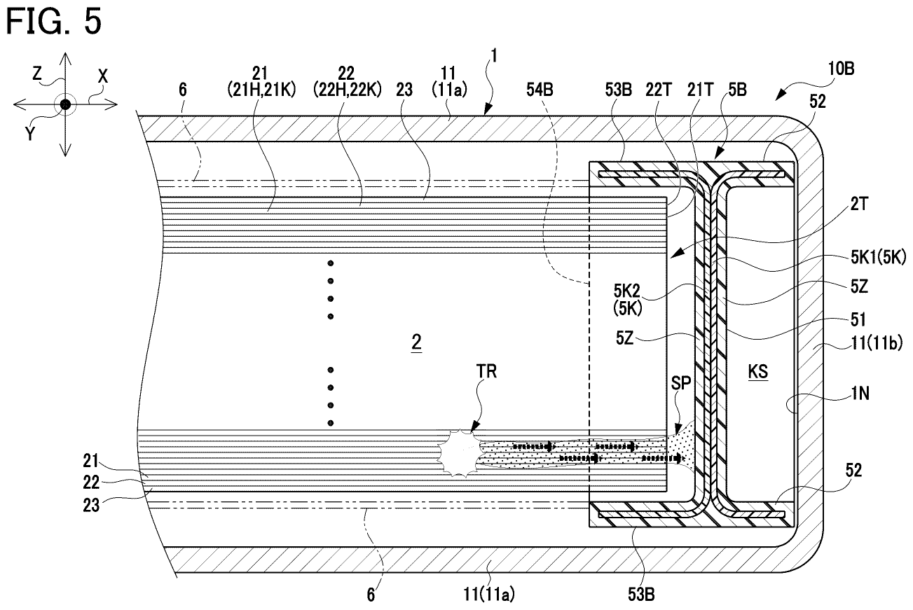

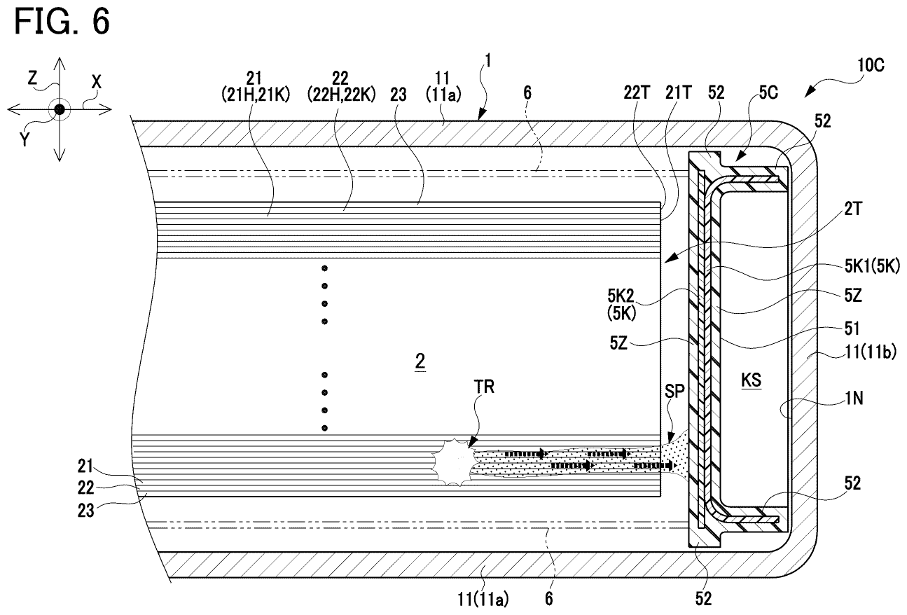

The above-described secondary battery 10 in the first example may be modified as below. FIG. 5 is a B-B cross-sectional diagram in a modified example 1 of the secondary battery shown in FIG. 1. FIG. 6 is a B-B cross-sectional diagram in a modified example 2 of the secondary battery shown in FIG. 1. A secondary battery 10B in the modified example 1 and a secondary battery 10C in the modified example 2 each include a shielding member that is a simplified version of the shielding member 5 of the secondary battery 10 in the first example, and the battery case 1, the electrode body 2, and the current collecting terminals 4 are common to each secondary battery. The following description is mainly given to the simplified shielding members 5B and 5C. The battery case 1, electrode body 2, and current collecting terminals 4, which are common to each secondary battery, are assigned the same reference signs as those in the first example and their descriptions are basically omitted.

The shielding member 5B of the secondary battery 10B in the modified example 1 is provided, as shown in FIG. 5, with a shielding portion 51 (corresponding to a short-wall-side shielding portion 51 in this example) facing an electrode-body open edge 2T where the edge portion 21T of the positive electrode 21 and the edge portion 22T of the negative electrode 22 are open in the direction perpendicular to the stacking direction of the electrode body 2, and the shield supporting portions 52 that support the shielding portion 51 at a distance from the inner wall surface IN of the battery case 1. The shielding member 5B is further provided with long-wall-side shielding portions 53B facing the long side wall 11a, each of which is shorter than the shielding portion 53 in the first example in the long-side direction and located near the electrode-body open edge 2T and between the electrode body 2 and the long side wall 11a of the case body 11, and a bottom-wall-side shielding portion 54B facing the bottom wall 11c, which is shorter than the shielding portion 54 in the first example in the long-side direction and located between the electrode body 2 and the bottom wall 11c of the case body 11. Further, as shown in FIG. 5, the shielding portion 51, the shield supporting portions 52, and the shielding portions 53B are formed such that respective metal members 5K are coated with the insulating member 5Z to have a H-shaped cross-section in plan view.

In this case, even if a large amount of ejected substances SP generated due to a short circuit TR or other failures between the positive electrode 21 and the negative electrode 22 is ejected in the direction perpendicular to the stacking direction of the electrode body 2 from the electrode-body open edge 2T where the edge portion 21T of the positive electrode 21 and the edge portion 22T of the negative electrode 22 are open, the short-wall-side shielding portion 51 facing the electrode-body open edge 2T can avoid collision of the ejected substances SP against the short side wall 11b of the case body 11. Since the shield supporting portions 52 hold the shielding portions 51 uniformly at a predetermined separation distance from the inner wall surface IN of the battery case 1, an air layer KS is uniformly formed between each shielding portion 51 and the battery case 1, suppressing the heat of the ejected substances SP from transferring from the shielding portions 51 to the inner wall surface IN of the battery case 1.

The shielding member 5B, which includes the shorter long-wall-side shielding portions 53B and the shorter bottom-wall-side shielding portion 54B, can suppress the ejected substances SP reflected from the short-wall-side shielding portions 51 from spattering or flying toward the long side walls 11a and the bottom wall 11c of the case body 11. Further, the long-wall-side shielding portions 53B and the bottom-wall-side shielding portion 54B are each has a reduced length in the long-side direction (the direction X), leading to significant weight reduction of the shielding member 5B. This can achieve simplification and weight reduction of the shielding member 5B while effectively blocking the heat of the ejected substances SP to reduce melting and rupture of the battery case 1.

The shielding member 5C of the secondary battery 10C in the modified example 2 is provided, as shown in FIG. 6, with a shielding portion 51 (corresponding to a short-wall-side shielding portion 51 in this example) facing the electrode-body open edge 2T where the edge portion 21T of the positive electrode 21 and the edge portion 22T of the negative electrode 22 are open in the direction perpendicular to the stacking direction of the electrode body 2, and the shield supporting portions 52 that support the shielding portion 51 at a distance from the inner wall surface IN of the battery case 1. Further, as shown in FIG. 6, the shielding portion 51 and the shield supporting portions 52 are formed such that respective metal members 5K (5K1, 5K2) are coated with the insulating member 5Z and connected to have a nearly U-shaped cross-section.

In this case, even if a large amount of ejected substances SP generated due to a short circuit TR or other failures between the positive electrode 21 and the negative electrode 22 is ejected in the direction perpendicular to the stacking direction of the electrode body 2 from the electrode-body open edge 2T where the edge portion 21T of the positive electrode 21 and the edge portion 22T of the negative electrode 22 are open, the short-wall-side shielding portion 51 facing the electrode-body open edge 2T can avoid collision of the ejected substances SP against the short side wall 11b of the case body 11. Since the shield supporting portions 52 hold the shielding portions 51 uniformly at a predetermined separation distance from the inner wall surface IN of the battery case 1, an air layer KS is formed between each shielding portion 51 and the battery case 1, suppressing the heat of the ejected substances SP from transferring from the shielding portions 51 to the inner wall surface IN of the battery case 1. Further, since the long-wall-side shielding portions 53 and the bottom-wall-side shielding portion 54B are eliminated, the shielding member 5C is further reduced in weight. This configuration can achieve simplification of the shielding member 5C leading to weight reduction and also effectively block the heat of the ejected substances SP to reduce melting and rupture of the battery case 1.

In the secondary battery 10B in the modified example 1 and the secondary battery 10C in the modified example 2, furthermore, each of the shielding members 5B and 5C may be connected to or is integrally formed with the insulating film 6 enclosing the electrode body 2. This configuration can also prevent positional displacement between the electrode body 2 and the shielding member 5B or 5C and thus can block the ejected substances SP more reliably. The shielding member 5B or 5C and the electrode body 2 can be accommodated together in the battery case 1, further simplifying the battery assembling works.

### Secondary Battery in Second Example

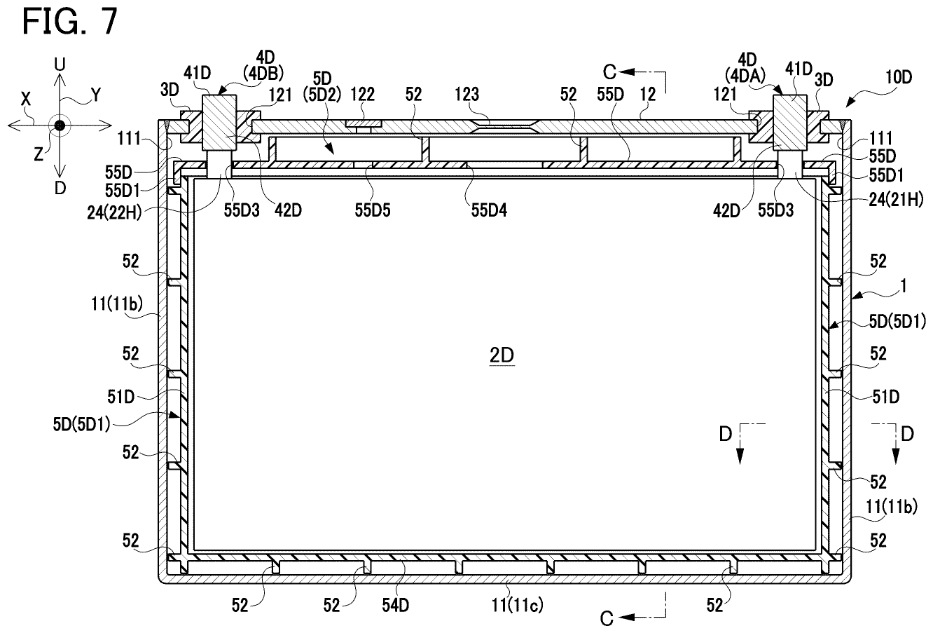

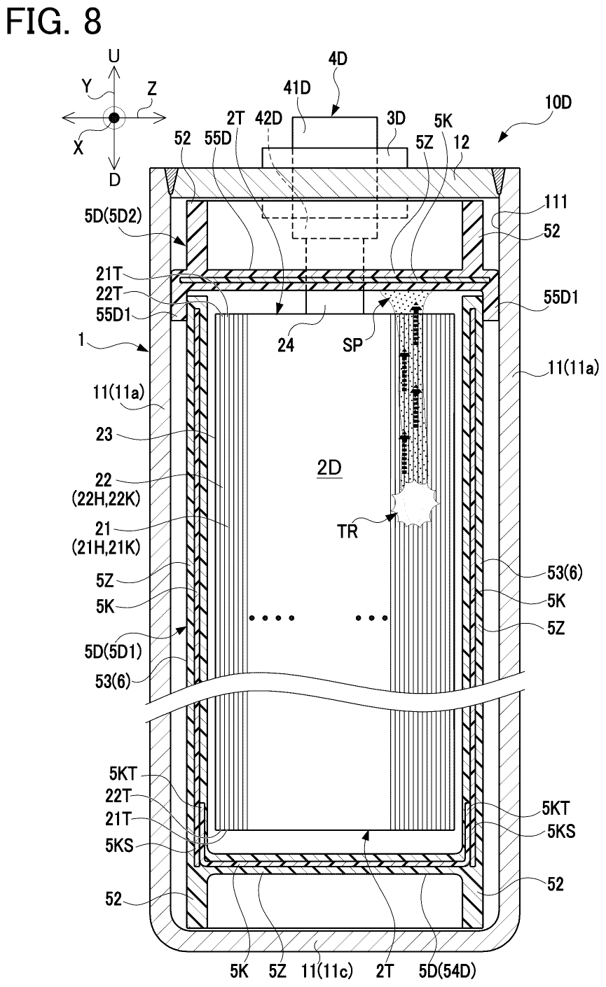

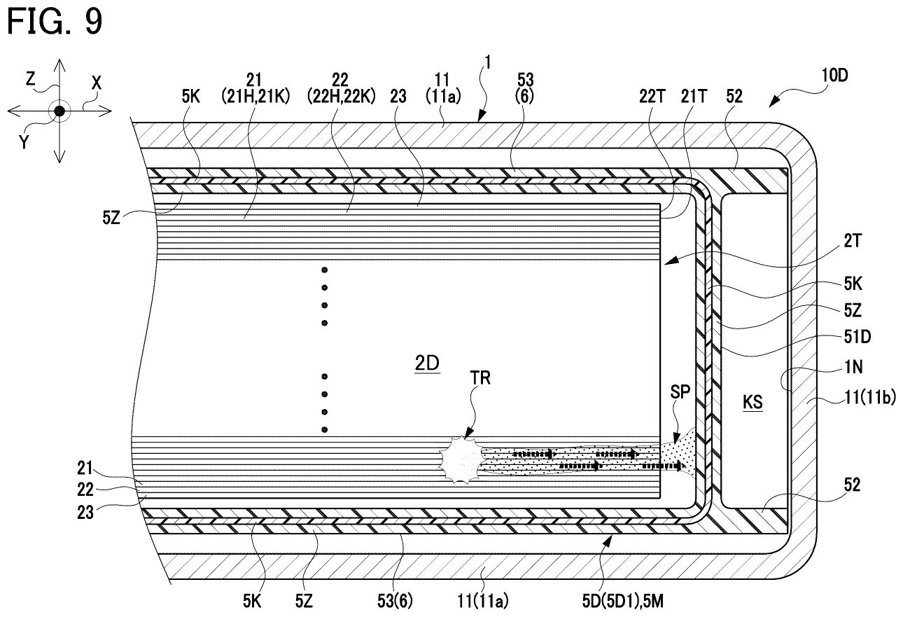

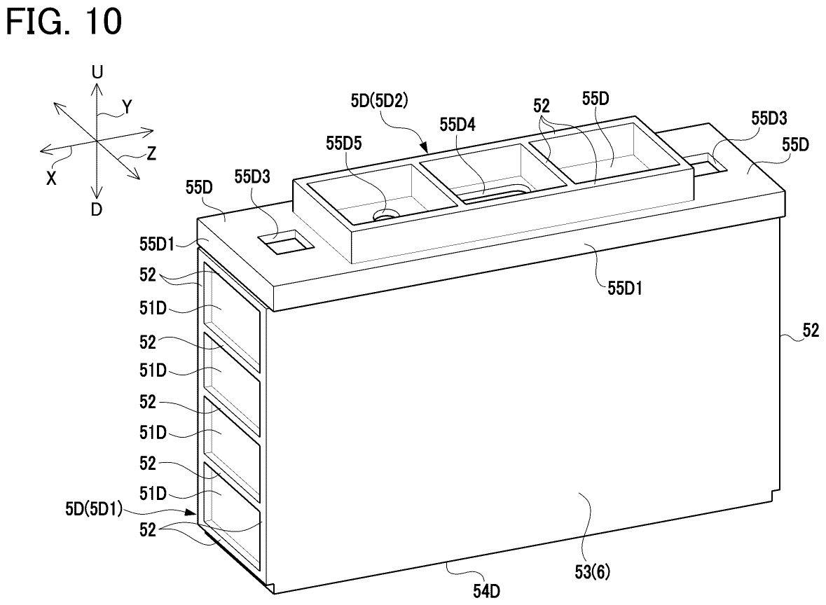

Next, a secondary battery in a second example, which is one aspect of the embodiment of the disclosure, will be described in detail referring to the drawings. FIG. 7 is a schematic cross-sectional diagram of the secondary battery in the second example, which is one aspect of the embodiment. FIG. 8 is a cross-sectional diagram taken along a line C-C in FIG. 7. FIG. 9 is a cross-sectional diagram taken along a line D-D in FIG. 7. FIG. 10 is a schematic perspective diagram of a shielding member in the secondary battery shown in FIG. 7.

A secondary battery 10D in the present second example is provided, as shown in FIGS. 7 to 10, a battery case 1, an electrode body 2D, current collecting terminals 4D, and a shielding member 5D. Parts in common with the secondary battery 10 in the first example are assigned the common reference signs and their details are basically omitted. The battery case 1 includes a bottomed rectangular prismatic case body 11 and a flat-plate-like lid member 12. The lid member 12 is formed, near its both ends in the long-side direction (the direction X), with insertion holes 121 for the current collecting terminals 4D (4DA, 4DB). An outer terminal 41D of each current collecting terminal 4D inserted in the corresponding insertion hole 121 is fixed to the lid member 12 via the insulating resin member 3. The insulating resin members 3 may be made of, for example, polyphenylene sulfide (PPS) resin.

Furthermore, the electrode body 2D includes rectangular positive electrodes 21 and rectangular negative electrodes 22, which are alternately stacked, forming a rectangular parallelepiped shape, with rectangular separators 23 interposed between them. The electrode body 2D includes tabs 24 of positive electrode foils 21H and tabs 24 of negative electrode foils 22H at an upper end parts of both end portions of in the long-side direction (the direction X). The tabs 24 of the positive electrode foils 21H are joined to an inner terminal 42D of a current collecting terminal 4DA for positive electrode and the tabs 24 of the negative electrode foils 22H are joined to an inner terminal 42 of a current collecting terminal 4DB for negative electrode.

The shielding member 5D further includes a first shielding member 5D1 placed between the electrode body 2D and the case body 11 and a second shielding member 5D2 placed between the electrode body 2D and the lid member 12 to shield against ejected substances SP that are ejected from the electrode body 2D toward the case body 11 and the lid member 12 due to, e.g., a short circuit TR between the positive electrodes 21 and the negative electrodes 22. The first shielding member 5D1 is formed in a bottomed rectangular prismatic shape, including short-wall-side shielding portions 51D, long-wall-side shielding portions 53, and a bottom-wall-side shielding portion 54D, which are integrally connected to each other. The second shielding member 5D2 is provided with a flat-plate-like shielding portion 55D placed to face the lid member 12, which will be also referred to as a lid-side shielding portion 55D, and an outer-circumferential contact portion 55D1 contacting with the short-wall-side shielding portions 51D and the long-wall-side shielding portions 53.

The lid-side shielding portion 55D is formed, near both ends in the long-side direction (the direction X), with tab insertion holes 55D3 in which the tabs 24 of the positive electrode foils 21H and the tabs 24 of the negative electrode foils 22H are inserted respectively. The shielding portion 55D is provided with an opening 55D5 for inlet, placed under the inlet 122 formed in the lid member 12, and an opening 55D4 for safety valve, placed under the safety valve 123. These openings allow an electrolyte poured into the battery case 1 through the inlet 122 to be easily impregnated in the electrode body 2 and allow the gas pressure that has risen due to a short circuit TR or other failures in the electrode body 2D to easily release out through the safety valve 123. The opening 55D4 for safety valve may be formed as a perforated part that can be opened according to the gas pressure.

The shielding member 5D in this example is provided with the shielding portions 51D, 54D, and 55D (herein, respectively corresponding to the short-wall-side shielding portions 51D, the bottom-wall-side shielding portion 54D, and the lid-side shielding portion 55D) facing the electrode-body open edge 2T where the edge portions 21T of the positive electrodes 21 and the edge portions 22T of the negative electrodes 22 are opened in the directions perpendicular to the stacking direction of the electrode body 2D, and the shield supporting portions 52 that support the shielding portions 51D, 54D, and 55D at a distance from the inner wall surface IN of the battery case 1.

This is because the ejected substances SP generated when the positive electrodes 21 and the negative electrodes 22 are short-circuited are mostly ejected from the electrode-body open edges 2T where the edge portions 21T of the positive electrodes 21 and the edge portions 22T of the negative electrodes 22 are opened in the directions perpendicular to the stacking direction of the electrode body 2D as shown in FIGS. 8 and 9, and the shielding portions 51D, 54D, 55D facing the electrode-body open edges 2T can more effectively shield against the ejected substances SP. Moreover, the shielding member 5D includes the shield supporting portions 52 that support the shielding portions 51D, 54D, and 55D at a distance from the inner wall surface IN of the battery case 1, so that an air layer KS is formed between each shielding portion 51D, 54D, 55D and the battery case 1, suppressing the heat of the ejected substances SP from transferring from the shielding portions 51D, 54D, and 55D to the inner wall surface IN of the battery case 1. This configuration can more effectively block the heat of the ejected substances SP to reduce melting and rupture of the battery case 1.

As shown in FIGS. 8 and 9, the shielding member 5D (5D1, 5D2) may be formed of the metal member 5K coated with the insulating member 5Z, the metal member 5K having a higher melting point than either the melting point of the positive electrode foils 21H or the melting point of the negative electrode foils 22H, whichever is higher. The shielding member 5D may be made of an insulating organic material 5M having a higher melting point than either the melting point of the positive electrode foils 21H or the melting point of the negative electrode foils 22H, whichever is higher. For the electrode body 2D of a rectangular parallelepiped stacked shape, the short-wall-side shielding portions 51D, the bottom-wall-side shielding portion 54D, and the lid-side shielding portion 55D, which are likely to be exposed to the ejected substances SP, may be each made of the metal member 5K coated with the insulating member 5Z, and other shielding portions 53, which enclose, or surround, the electrode body 2D, may be formed of the insulating film 6 made of only the insulating member 5Z, and the shielding portions 51D, 54D, 55D may be connected to or integrally formed with the shielding portions 53, i.e., the insulating film 6.

### Secondary Battery in Third Example

Next, a secondary battery in a third example, which is one aspect of the embodiment of the disclosure, will be described in detail referring to the drawings.

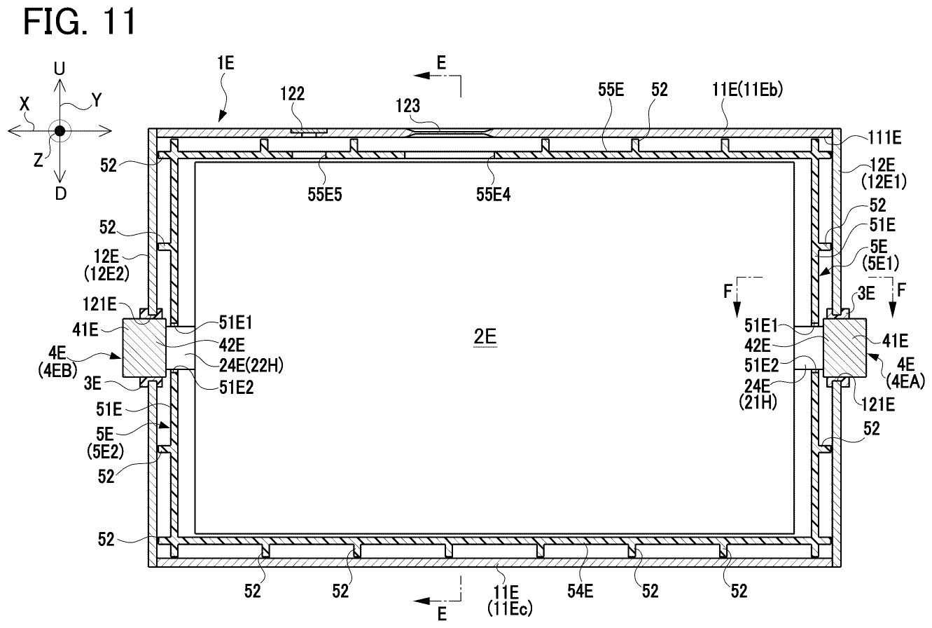

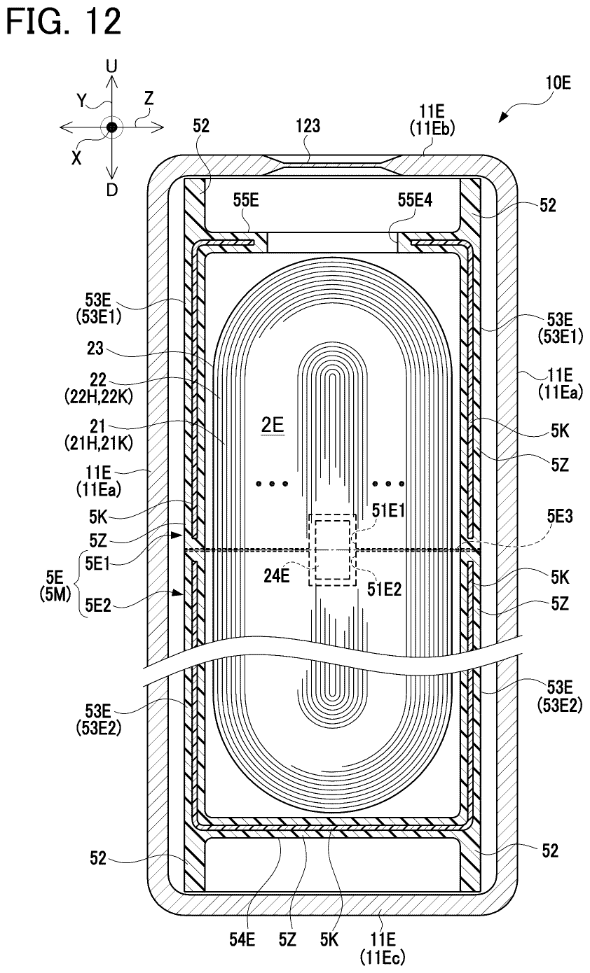

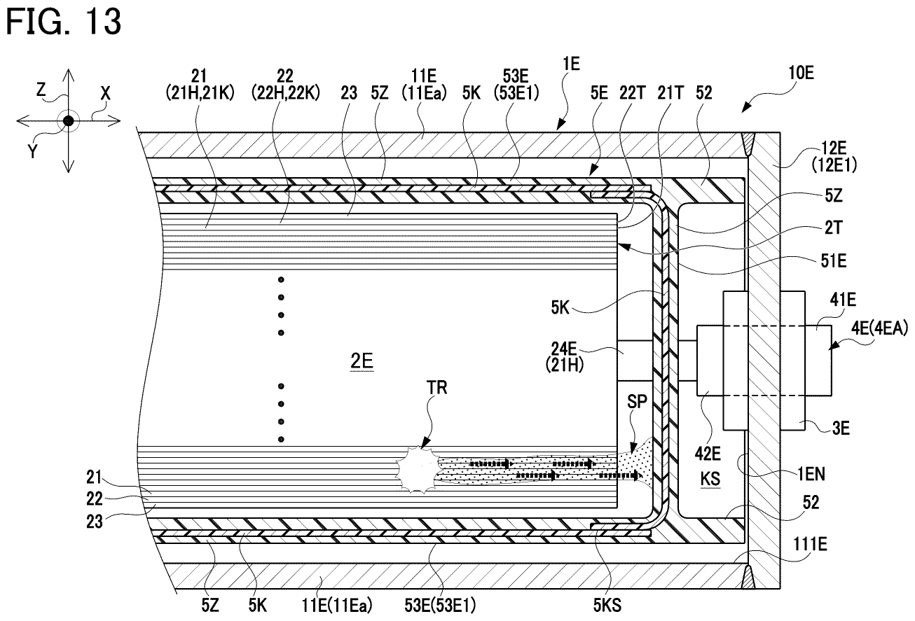

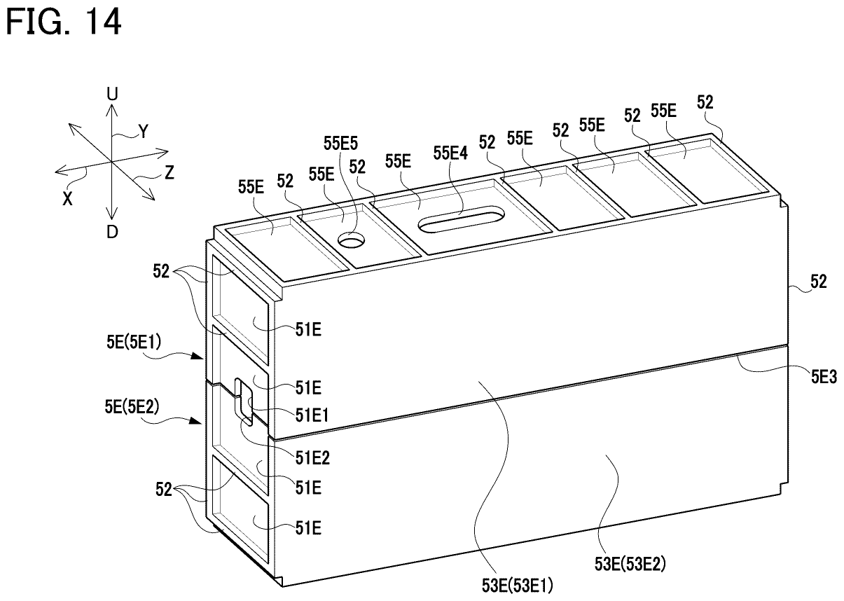

FIG. 11 is a schematic cross-sectional diagram of the secondary battery in the third example, which is one aspect of the embodiment. FIG. 12 is a cross-sectional diagram taken along an E-E line in FIG. 11. FIG. 13 is a cross-sectional diagram taken along an F-F line in FIG. 11. FIG. 14 is a schematic perspective view of a shielding member in the secondary battery shown in FIG. 11.

A secondary battery 10E in the third example is provided with a battery case 1E, an electrode body 2E, current collecting terminals 4E (4EA, 4EB), and a shielding member 5E, as shown in FIGS. 11 to 14. The common parts to the secondary battery 10 in the first example are assigned the common reference signs and their details are omitted. The battery case 1E includes a prismatic case body 11E having rectangular opening portions 111E at both ends in the long-side direction (the direction X), and flat-plate-like lid members 12E (12E1, 12E2) that hermetically close the corresponding opening portions 111E. The case body 11E has an upper wall 11Eb, opposed long side walls 11Ea, and a bottom wall 11Ec, and the upper wall 11Eb is formed with the inlet 122 and the safety valve 123. Further, in the center of each lid member 12E in the vertical direction (the direction Y), an insertion hole 121E in which the current collecting terminal 4E is inserted is formed. An outer terminal 41E of each current collecting terminal 4E inserted in the corresponding insertion hole 121E is fixed to the lid member 12E via an insulating resin member 3E. The insulating resin members 3E may be made of, for example, polyphenylene sulfide (PPS) resin.

The electrode body 2E in this example includes a strip-shaped positive electrode 21 and a strip-shaped negative electrode 22, which are alternately laminated with strip-shaped separators 23 interposed between them and wound together in a flat shape. As an alternative, for example, the electrode body 2E may include rectangular positive electrodes 21 and rectangular negative electrodes 22, which are stacked in a rectangular parallelepiped shape with rectangular separators 23 interposed between them. The electrode body 2E includes tabs 24E of the positive electrode foil 21H and tabs 24E of the negative electrode foil 22H at the centers of both edges in the long-side direction (the direction X). The tabs 24E of the positive electrode foil 21H are joined to an inner terminal 42E of a current collecting terminal 4EA for positive electrode, and the tabs 24E of the negative electrode foil 22H are joined to an inner terminal 42E of a current collecting terminal 4EB for negative electrode.

The shielding member 5E further includes a first shielding member 5E1 and a second shielding member 5E2, which are divided along a partition line 5E3 passing through the center of the insertion holes 121E. Specifically, the first shielding member 5E1 is placed between the electrode body 2E and upper parts of the case body 11E and the lid member 12E, which are located above the partition line 5E3, and the second shielding member 5E2 is placed between the electrode body 2E and lower parts of the case body 11E and the lid member 12E, which are located below the partition line 5E3. The shielding member 5E is configured to shield against ejected substances SP, which are ejected due to a short circuit TR or other failures between the positive electrode 21 and the negative electrode 22 toward the case body 11E and the lid member 12E.

The first shielding member 5E1 has a rectangular prismatic shape with a closed top, and includes shielding portions 51E facing the lid members 12E, which will be referred to as lid-side shielding portions 51E, long-wall-side shielding portions 53E (53E1), and a shielding portion 55E facing the upper wall, which will be referred to as an upper-wall-side shielding portion 55E, and those shielding portions are integrally connected to each other. The second shielding member 5E2 has a rectangular prismatic shape with a closed bottom, and includes lid-side shielding portions 51E, long-wall-side shielding portions 53E (53E2), and a bottom-wall-side shielding portion 54E, and those shielding portions are integrally connected to each other. The first shielding member 5E1 and the second shielding member 5E2 abut on each other at the partition line 5E3.

Further, the upper-wall-side shielding portion 55E of the first shielding member 5E1 is provided with an opening 55E5 for inlet, formed under the inlet 122, and an opening 55E4 for safety valve, formed under the safety valve 123. These openings allow an electrolyte poured into the battery case 1 through the inlet 122 to be easily impregnated in the electrode body 2E and allow the gas pressure that has risen due to a short circuit TR or other failures in the electrode body 2E to easily release out through the safety valve 123. The opening 55E4 for safety valve may be formed as a perforated part that can be opened according to the gas pressure.

The shielding member 5E in this example is provided with the shielding portions 51E (herein, corresponding to the lid-side shielding portions 51E) facing the electrode-body open edges 2T where the edge portion 21T of the positive electrode 21 and the edge portion 22T of the negative electrode 22 are opened in the direction perpendicular to the stacking direction of the electrode body 2E, and the shield supporting portions 52 that support the shielding portions 51E at a distance from the inner wall surface 1EN of the battery case 1E.

This is because the ejected substances SP generated when the positive electrode 21 and the negative electrode 22 are short-circuited are mostly ejected from the electrode-body open edges 2T where the edge portions 21T of the positive electrode 21 and the edge portions 22T of the negative electrode 22 are opened in the direction perpendicular to the stacking direction of the electrode body 2E as shown in FIG. 13, and the shielding portions 51E facing the electrode-body open edges 2T can shield against, or block, the ejected substances SP more effectively. Moreover, the shielding portions 51E include the shield supporting portions 52 that support the shielding portions 51E at a distance from the inner wall surface 1EN of the battery case 1E, so that an air layer KS is formed between each shielding portion 51E and the battery case 1E, suppressing the heat of the ejected substances SP from transferring from the shielding portions 51E to the inner wall surface 1EN of the battery case 1E.

This configuration can more effectively block the heat of the ejected substances SP to reduce melting and rupture of the battery case 1E.

As shown in FIGS. 12 and 13, the shielding member 5E (5E1, 5E2) may be formed of the metal member 5K coated with the insulating member 5Z, in which the metal member 5K has a higher melting point than either the melting point of the positive electrode foil 21H or the melting point of the negative electrode foil 22H, whichever is higher. The shielding member 5E may also be formed of an insulating organic material 5M having a higher melting point than either the melting point of the positive electrode foil 21H or the melting point of the negative electrode foil 22H, whichever is higher. For the electrode body 2E of a rectangular parallelepiped stacked shape, the lid-side shielding portion 51E, the upper-wall-side shielding portion 55E, and the bottom-wall-side shielding portion 54E, which are likely to be exposed to the ejected substances SP, may be each made of the metal member 5K coated with the insulating member 5Z, and other shielding portions 53E enclosing the electrode body 2E may be formed of the insulating film 6 made of only the insulating member 5Z, and the shielding portions 51E, 55E, 54E may be joined to or integrally formed with the shielding portion 53E.

### Variations

The foregoing examples are mere examples and give no limitation to the present disclosure. The present disclosure may be embodied in other specific forms without departing from the essential characteristics thereof.

### REFERENCE SIGNS LIST

1,1D, 1E Battery case
2, 2D, 2E Electrode body
2T Electrode-body open edge
5,5B, 5C, 5D, 5E Shielding member
5K Metal member
5M Insulating organic material
5Z Insulating member
6 Insulating film
10, 10B, 10C, 10D, 10E Secondary battery
21 Positive electrode
21H Positive electrode foil
21K Positive active material layer
21T Edge portion
22 Negative electrode
22H Negative electrode foil
22K Negative active material layer
22T Edge portion
23 Separator
51, 51D, 51E
53, 53B Shielding portion
54, 54B, 54D, 54E Shielding portion
55, 55D, 55E Shielding portion
52 Shield supporting portion

What is claimed is:

1. A secondary battery comprising:
an electrode body including a positive electrode formed of a positive electrode foil coated with a positive active material layer and a negative electrode formed of a negative electrode foil coated with a negative active material layer, the positive and negative electrodes being stacked with separators interposed between them;
a battery case in which the electrode body is hermetically housed; and
a shielding member placed between the electrode body and the battery case to shield against ejected substances that are ejected from the electrode body toward the battery case.

2. The secondary battery according to claim 1, wherein
the shielding member includes:
a shielding portion placed facing an electrode-body open edge where an edge portion of the positive electrode and an edge portion of the negative electrode are opened in a direction perpendicular to a stacking direction of the electrode body; and
a shield supporting portion that supports the shielding portion at a distance from an inner wall surface of the battery case.

3. The secondary battery according to claim 1, wherein the shielding member is formed of (i) a metal member coated with an insulating member, the metal member having a melting point higher than either a melting point of the positive electrode foil or a melting point of the negative electrode foil, whichever is higher, or (ii) an insulating organic material having a melting point higher than either the melting point of the positive electrode foil or the melting point of the negative electrode foil, whichever is higher.

4. The secondary battery according to claim 2, wherein the shielding member is formed of (i) a metal member coated with an insulating member, the metal member having a melting point higher than either a melting point of the positive electrode foil or a melting point of the negative electrode foil, whichever is higher, or (ii) an insulating organic material having a melting point higher than either the melting point of the positive electrode foil or the melting point of the negative electrode foil, whichever is higher.

5. The secondary battery according to claim 1, wherein the shielding member is connected to or integrally formed with an insulating film enclosing the electrode body.

6. The secondary battery according to claim 2, wherein the shielding member is connected to or integrally formed with an insulating film enclosing the electrode body.

7. The secondary battery according to claim 3, wherein the shielding member is connected to or integrally formed with an insulating film enclosing the electrode body.

8. The secondary battery according to claim 4, wherein the shielding member is connected to or integrally formed with an insulating film enclosing the electrode body.
